(19) United States
(12) Patent Application Publication
(10) Pub. No.: US 2026/0222993 A1
(43) Pub. Date: Jul. 30, 2026

(54) LOW-POWER MODE WAKE-UP METHOD AND APPARATUS, AND STORAGE MEDIUM

(71) Applicant: Beijing Xiaomi Mobile Software Co., Ltd., Beijing (CN)

(72) Inventor: Shengxiang GUO, Beijing (CN)

(21) Appl. No.: 19/141,761

(22) PCT Filed: Dec. 23, 2022
(86) PCT No.: PCT/CN2022/141632

§ 371 Date: Jun. 20, 2025

(51) Int. Cl. H04W 52/02; H04W 72/23

(52) U.S. Cl. CPC H04W 52/0235; H04W 72/23

(57) ABSTRACT

A wake-up method in a low power mode is performed by a base station, and includes: determining a transmission beam for a low power wake-up signal, wherein one or more reception beams for receiving the low power wake-up signal by a terminal correspond to the transmission beam; and transmitting the low power wake-up signal to the terminal according to the transmission beam.

### CROSS-REFERENCE TO RELATED APPLICATION

This application is the U.S. national phase application of International Application No. PCT/CN2022/141632, filed on Dec. 23, 2022, the disclosure of which is incorporated herein by reference in its entirety.

### TECHNICAL FIELD

The present disclosure relates to the field of communications, and in particular to a wake-up method in a low power mode, a wake-up apparatus in a low power mode, and a storage medium.

### BACKGROUND

In related arts, it is expected that a low power wake-up signal (LP WUS) transmitted by a base station is transmitted in a determined beam direction. Therefore, it is expected to associate the LP WUS with beam information. Generally, the base station configures a transmission beam for the LP WUS for a terminal, and the terminal performs beam matching by itself based on the transmission beam and stores a best beam pair at the terminal. After the terminal sleeps, information on the transmission beam of the base station may change, so that a correspondence between a reception beam of the terminal and the transmission beam of the base station may change, which further decreases a reception quality of the LP WUS.

### SUMMARY

According to a first aspect of the examples of the present disclosure, a wake-up method in a low power mode is provided, which is performed by a base station, including: determining a transmission beam for a low power wake-up signal, wherein one or more reception beams for receiving the low power wake-up signal by a terminal correspond to the transmission beam; and transmitting the low power wake-up signal to the terminal according to the transmission beam.

According to a second aspect of the examples of the present disclosure, a wake-up method in a low power mode is provided, which is performed by a terminal, including: determining one or more reception beams, wherein the one or more reception beams correspond to a transmission beam through which a base station transmits a low power wake-up signal; receiving, according to the one or more reception beams, the low power wake-up signal transmitted by the base station; and performing a wake-up or changing a sleep state based on the low power wake-up signal.

According to a third aspect of the examples of the present disclosure, a communication device is provided, including: one or more processors; and one or more memories for storing instructions executable by the one or more processors. The one or more processors are configured to: determine one or more reception beams, wherein the one or more reception beams correspond to a transmission beam through which a base station transmits a low power wake-up signal; receive, according to the one or more reception beams, the low power wake-up signal transmitted by the base station; and perform a wake-up or changing a sleep state based on the low power wake-up signal.

It is to be understood that the foregoing general description and the following detailed description are illustrative and explanatory only and are not restrictive of the present disclosure.

### BRIEF DESCRIPTION OF THE DRAWINGS

The above and/or additional aspects and advantages of the present disclosure will become apparent and readily understood according to the following description of the examples in conjunction with the accompanying drawings.

FIG. 1A illustrates a schematic diagram of a system architecture applicable to examples of the present disclosure.

FIG. 1B illustrates a schematic diagram of a 5G system architecture.

FIG. 2 is a flowchart illustrating a wake-up method in a low power mode according to an example.

FIG. 3 is a flowchart illustrating a wake-up method in a low power mode according to an example.

FIG. 4 is a flowchart illustrating a wake-up method in a low power mode according to an example.

FIG. 5 is a flowchart illustrating a wake-up method in a low power mode according to an example.

FIG. 6 is a flowchart illustrating a wake-up method in a low power mode according to an example.

FIG. 7 is a flowchart illustrating a wake-up method in a low power mode according to an example.

FIG. 8 is a flowchart illustrating a wake-up method in a low power mode according to an example.

FIG. 9 is a flowchart illustrating a wake-up method in a low power mode according to an example.

FIG. 10 is a flowchart illustrating a wake-up method in a low power mode according to an example.

FIG. 11 is a flowchart illustrating a wake-up method in a low power mode according to an example.

FIG. 12 is a flowchart illustrating a wake-up method in a low power mode according to an example.

FIG. 13 is a flowchart illustrating a wake-up method in a low power mode according to an example.

FIG. 14 is a flowchart illustrating a wake-up method in a low power mode according to an example.

FIG. 15 is a flowchart illustrating a wake-up method in a low power mode according to an example.

FIG. 16 is a flowchart illustrating a wake-up method in a low power mode according to an example.

FIG. 17 is a flowchart illustrating a wake-up method in a low power mode according to an example.

FIG. 18 is a block diagram illustrating a wake-up apparatus in a low power mode according to an example.

FIG. 19 is a block diagram illustrating a wake-up apparatus in a low power mode according to an example.

FIG. 20 is a block diagram illustrating a wake-up apparatus in a low power mode according to an example.

FIG. 21 is a block diagram illustrating a wake-up apparatus in a low power mode according to an example.

### DETAILED DESCRIPTION OF THE EMBODIMENTS

Examples will be described in detail here with the illustrations thereof illustrated in the drawings. Where the following descriptions involve the drawings, like numerals in different drawings refer to like or similar elements unless otherwise indicated. The implementations described in the following examples do not represent all implementations consistent with the present disclosure. Rather, they are merely examples of apparatuses and methods consistent with some aspects of the present disclosure as detailed in the appended claims.

First, the present disclosure introduces the relevant technologies.

In downlink beam management, for any one of M candidate transmission beams, a terminal uses N candidate reception beams to perform reception measurements to find a best transmission and reception beam pair. The number of the reception beams, N, selected by the terminal and the implementation scheme are confirmed by the terminal, without being reported to a base station. In addition, the best reception beam corresponding to the transmission beam is stored at the terminal, without being reported to the base station.

Furthermore, a low power (LP) wake-up signal (WUS) is introduced in related arts. The LP WUS uses a special receiver, called a low power wake-up signal receiver (LP-WUR). Normally, the terminal is expected to process downlink and/or uplink data using a main radio (MR). The terminal activates the main radio to receive and process downlink and/or uplink signals upon receiving the WUS that indicates to wake up, and keeps the main radio in a sleep state if it receives no WUS or the WUS indicates not to wake up. The WUS may be used in a radio resource control (RRC) connected state, an inactive state, an idle state, etc. The sleep states of the MR include four types: an ultra-deep sleep, a deep sleep, a light sleep, and a micro sleep.

In related arts, it is expected that the LP WUS transmitted by the base station is transmitted in a determined beam direction. Therefore, it is expected to associate the LP WUS with beam information. Generally, the base station configures a transmission beam for the LP WUS for the terminal, and the terminal performs beam matching by itself based on the transmission beam and stores a best beam pair at the terminal. After the terminal sleeps, information on the transmission beam of the base station may change, so that a correspondence between a reception beam of the terminal and the transmission beam of the base station may change, which further decreases a reception quality of the LP WUS.

In order to overcome the problems in the related arts, the present disclosure provides a wake-up method in a low power mode, a wake-up apparatus in a low power mode, and a storage medium.

In the technical solutions provided in the examples of the present disclosure, it determines by a base station a transmission beam for a low power wake-up signal and transmits the low power wake-up signal according to the transmission beam, and meanwhile makes one or more reception beams through which a terminal receives the low power wake-up signal correspond to the transmission beam, which can effectively avoid a problem of reduced reception quality of the low power wake-up signal due to a change of the transmission beam or the reception beam.

An implementation environment of the examples of the present disclosure is first introduced below.

The examples of the present disclosure may be applicable to a fourth generation mobile communication system (4G) evolution system, such as a long term evolution (LTE) system, to a fifth generation mobile communication system (5G) system, such as an access network using a new radio access technology (RAT), to a cloud radio access network (CRAN) or to other communication systems.

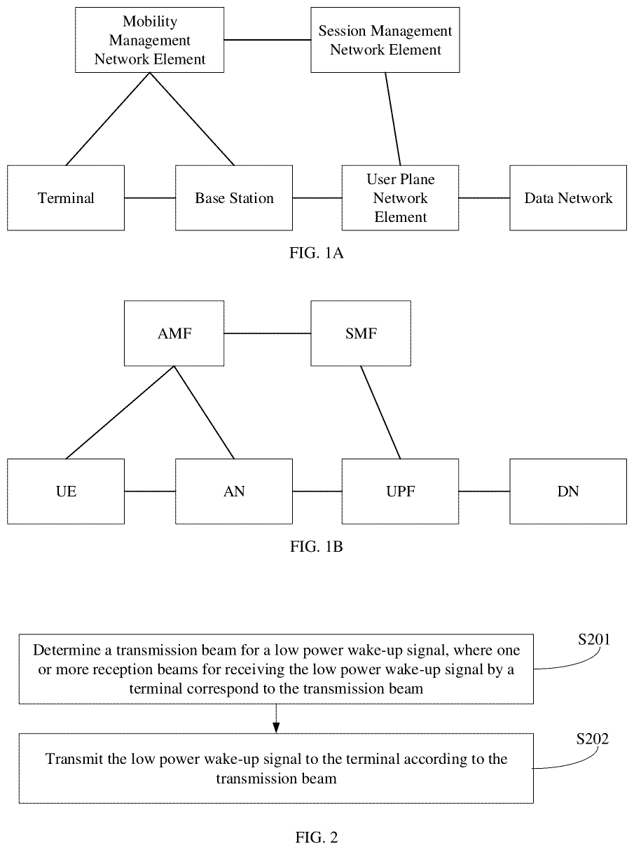

FIG. 1A illustrates a schematic diagram of a system architecture applicable to the examples of the present disclosure. It is to be understood that the examples of the present disclosure are not limited to the system illustrated in FIG. 1A. In addition, the elements in FIG. 1A may be hardware, or software divided by functionality, or a structure by combining the two. As illustrated in FIG. 1A, the system architecture provided in the example of the present disclosure includes a terminal, a base station, a mobility management network element, a session management network element, a user plane network element, and a data network (DN). The terminal communicates with the DN through the base station and the user plane network element.

The network element illustrated in FIG. 1A may be a network element in a 4G architecture or a network element in a 5G architecture.

The DN, which provides data transmission services for users, may be a protocol data unit network (PDN), such as the Internet and Internet protocol (IP) multi-media services (IMSs).

Making reference to a schematic diagram of a 5G system architecture illustrated in FIG. 1B, the mobility management network element may include an access and mobility management function (AMF) in the 5G. The mobility management network element is responsible for terminal access and mobility management in the mobile network. Particularly, the AMF is responsible for terminal access and mobility management, non-access stratum (NAS) message routing, session management function (SMF) selection, etc. The AMF may be used as an intermediate network element to transmit session management messages between the terminal and the SMF.

The session management network element is responsible for forwarding path management, such as issuing message forwarding policies to the user plane network element, instructing the user plane network element to process and forward messages in accordance to the message forwarding policies. The session management network element, which may be the SMF in the 5G (as illustrated in FIG. 1B), is responsible for session management such as session creation/modification/deletion, user plane network element selection, and allocation and management of user plane tunnel information, etc.

The user plane network element may be a user plane function (UPF) in the 5G architecture, as illustrated in FIG. 1B. The UPF is responsible for processing and forwarding messages.

The system architecture provided in the example of the present disclosure may also include a data management network element, which is responsible for processing terminal device identifications, access authentication, registration, and mobility management, etc. In a 5G communication system, the data management network element may be a unified data management (UDM) network element.

The system architecture provided in the example of the present disclosure may also include a policy control function (PCF) or a policy and charging control function (PCRF). Particularly, the PCF or the PCRF is responsible for policy control decision and flow-based charging control.

The system architecture provided in the example of the present disclosure may also include a network storage network element, which is used for maintaining real-time information of all network function services in the network. In the 5G communication system, the network storage network element may be a network repository function (NRF) network element. The NRF may store information of a lot of network elements, such as information of the SMF, information of the UPF, and information of the AMF. The network elements such as the AMF, the SMF and the UPF in the network may all be connected to the NRF. On the one hand, they may register their own network element information to the NRF, and on the other hand, other network elements may obtain the information of the registered network elements from the NRF. Other network elements (such as the AMF) may obtain a selectable network element by requesting the NRF based on a network element type, a data network identifier, unknown area information, etc. If a domain name system (DNS) server is integrated in the NRF, a corresponding selection function network element (such as the AMF) may request the NRF to obtain one or more other network elements to be selected (such as the SMF).

As a specific implementation of an access network (AN), the base station may also be called an access node. In a case of radio access, it is called a radio access network (RAN), as illustrated in FIG. 1B, providing radio access services for the terminal. The access node may specifically be a base station in a global system for mobile communication (GSM) system or a code division multiple access (CDMA) system, may be a NodeB in a wideband code division multiple access (WCDMA) system, may be an evolutional node B (eNB or eNodeB) in an LTE system, or may be a base station device, a small base station device, a wireless access point (WiFiAP), a worldwide interoperability for microwave access base station (WiMAX BS) in the 5G network, etc., which are not limited in the present disclosure.

The terminal may be referred to as an access terminal, user equipment (UE), a user unit, a user station, a mobile station, a mobile console, a remote station, a remote terminal, a mobile device, a user terminal, a wireless communication device, a user agent or a user device. FIG. 1B is illustrated by taking the UE as an example. The terminal may be a cellular phone, a cordless phone, a session initiation protocol (SIP) phone, a wireless local loop (WLL) station, a personal digital assistant (PDA), a handheld device with wireless communication functions, a computing device or other processing device connected to a wireless modem, a vehicle-mounted device, a wearable device, an Internet of Things terminal device such as a fire detection sensor, a smart water/electricity meter, and a factory monitoring device.

These functions may be network elements in hardware devices, software functions running on dedicated hardware, or virtualized functions instantiated on a platform (e.g., a cloud platform).

In the communication system architecture, the base station and the terminal may be taken as part of the communication system, and are used to perform the steps mentioned in the following method examples separately.

FIG. 2 is a flowchart illustrating a wake-up method in a low power mode according to an example. The method is performed by a base station. As illustrated in FIG. 2, the method includes steps S201-S202.

At S201, a transmission beam for a low power wake-up signal is determined, where one or more reception beams for receiving the low power wake-up signal by a terminal correspond to the transmission beam.

At S202, the low power wake-up signal is transmitted to the terminal according to the transmission beam.

Particularly, for the terminal without data transmissions and receptions, its main radio may be in a sleep state of different degrees. The main radio includes a main receiver and/or a main transceiver. The base station determines the transmission beam for the low power wake-up signal, and transmits the low power wake-up signal according to the determined transmission beam. The terminal receives the low power wake-up signal through a low power wake-up receiver, and determines whether the main radio is awakened from the sleep state or enters a lighter sleep state based on the low power wake-up signal.

For example, the terminal performs a wake-up or change the sleep state in response to the low power wake-up signal, which may include switching from an ultra-deep sleep to a deep sleep, or switching from a micro sleep to a light sleep, or switching from a deep sleep to a wake-up state, etc. The specific mode to be switched from or to be switched to may be determined based on the terminal's own capabilities, the current sleep state, and the low power wake-up signal.

Particularly, the base station may adopt the transmission beam determined in different schemes in step S201, and correspondingly, the terminal may adopt the corresponding scheme to determine the one or more reception beams, so that the one or more reception beams through which the terminal receives the low power wake-up signal correspond to the transmission beam determined by the base station.

For example, the base station and the terminal may be uniformly configured to determine the transmission beam and the one or more reception beams in the corresponding beam determination scheme, respectively, so that the transmission beam and the one or more reception beams correspond to each other. Alternatively, the base station may indicate information related to the transmission beam to the terminal, so that the transmission beam of the base station corresponds to the one or more reception beams of the terminal. What beam determination scheme that the base station and the terminal adopt specifically is to be described in detail in the following examples and is not repeated here.

In an example, the one or more reception beams include at least one of the following: a best reception beam corresponding to the transmission beam; or one or more secondary-best reception beams corresponding to the transmission beam.

It is to be understood that the best reception beam is one that has the best correspondence with the transmission beam. The secondary-best reception beam is one with some directional offset on the basis of the best reception beam, which avoids a problem that the best reception beam cannot reliably receive the low power wake-up signal due to some directional offset of the transmission beam.

Particularly, the one or more secondary-best reception beams may include multiple levels of secondary-best reception beams. Each level of secondary-best reception beam has a different directional offset. For example, there may be a second best reception beam, a third best reception beam, a fourth best reception beam, and so on. Relevant technicians may perform the configuration according to specific requirements, which is not limited specifically in the present disclosure.

In the example of the present disclosure, it determines by the base station the transmission beam for the low power wake-up signal and transmits the low power wake-up signal according to the transmission beam, and meanwhile makes the one or more reception beams through which the terminal receives the low power wake-up signal correspond to the transmission beam, which can effectively avoid a problem of reduced reception quality of the low power wake-up signal due to a change of the transmission beam or the reception beam.

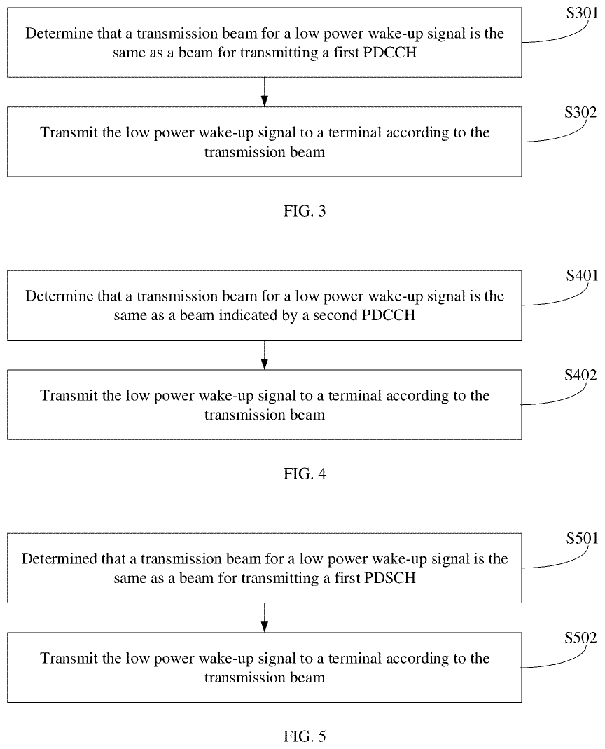

FIG. 3 is a flowchart illustrating a wake-up method in a low power mode according to an example. The method is performed by a base station. As illustrated in FIG. 3, the method includes steps S301-S302.

At S301, it is determined that a transmission beam for a low power wake-up signal is the same as a beam for transmitting a first physical downlink control channel (PDCCH).

At S302, the low power wake-up signal is transmitted to a terminal according to the transmission beam.

Particularly, the first PDCCH carries the last downlink control information (DCI) that is received by the terminal before a main radio sleeps, or the first PDCCH is the last PDCCH that is received by the terminal before the main radio sleeps, or the first PDCCH schedules the last physical downlink shared channel (PDSCH) that is received before the terminal sleeps, or the first PDCCH schedules a PDSCH for the last hybrid automatic repeat request (HARQ) feedback before the terminal sleeps.

It is to be understood that the PDCCH may specifically refer to data carried by the PDCCH, and the PDSCH may specifically refer to data carried by the PDSCH. For example, the first PDCCH carrying the last DCI that is received by the terminal before the main radio sleeps may represent that the data carried by the PDCCH includes the last DCI that is received before the main radio sleeps.

Additionally, and correspondingly, if the base station determines the transmission beam in the scheme of step S301, the terminal may determine one or more reception beams corresponding to the transmission beam in the corresponding scheme. For example, if the base station determines that the transmission beam for the low power wake-up signal is the same as the transmission beam for the PDCCH carrying the last DCI that is received by the terminal before the main radio sleeps, the terminal may determine one or more corresponding reception beams based on the transmission beam for the PDCCH. If the base station determines that the transmission beam for the low power wake-up signal is the same as the transmission beam for the last PDCCH that is received by the terminal before the main radio sleeps, the terminal may also determine one or more corresponding reception beams based on the transmission beam for the PDCCH.

In an example, the one or more reception beams include at least one of the following: a best reception beam corresponding to the transmission beam; or one or more secondary-best reception beams corresponding to the transmission beam.

It is to be understood that the best reception beam is one that has the best correspondence with the transmission beam, and the secondary-best reception beam is one with some directional offset on the basis of the best reception beam.

Particularly, the one or more secondary-best reception beams may include multiple levels of secondary-best reception beams. Each level of secondary-best reception beam has a different directional offset. For example, there may be a second best reception beam, a third best reception beam, a fourth best reception beam, and so on. Relevant technicians may perform the configuration according to specific requirements, which is not limited specifically in the present disclosure.

In the example of the present disclosure, it determines, by the base station and based on the transmission beam adopted for the first PDCCH transmitted by the base station, the transmission beam for the low power wake-up signal and transmits the low power wake-up signal according to the transmission beam, and meanwhile makes the one or more reception beams through which the terminal receives the low power wake-up signal correspond to the transmission beam, which can effectively avoid a problem of reduced reception quality of the low power wake-up signal due to a change of the transmission beam or the reception beam.

FIG. 4 is a flowchart illustrating a wake-up method in a low power mode according to an example. The method is performed by a base station. As illustrated in FIG. 4, the method includes steps S401-S402.

At S401, it is determined that a transmission beam for a low power wake-up signal is the same as a beam indicated by a second PDCCH.

At S402, the low power wake-up signal is transmitted to a terminal according to the transmission beam.

Particularly, the second PDCCH carries the last DCI that is received by the terminal before a main radio sleeps. Alternatively, the second PDCCH is the last PDCCH that is received by the terminal before the main radio sleeps.

It is to be understood that the second PDCCH may carry information corresponding to one or more transmission beams, and the information may indicate the transmission beam for the low power wake-up signal. Specifically, the information corresponding to the one or more transmission beams may be carried by the DCI carried by the second PDCCH.

Correspondingly, if the base station determines the transmission beam in the scheme of step S401, the terminal may determine one or more reception beams corresponding to the transmission beam in the corresponding scheme. For example, the terminal may determine that one or more reception beams through which it receives the low power wake-up signal correspond to the transmission beam for the low power wake-up signal notified by the second PDCCH.

In an example, the one or more reception beams include at least one of the following: a best reception beam corresponding to the transmission beam; or one or more secondary-best reception beams corresponding to the transmission beam.

It is to be understood that the best reception beam is one that has the best correspondence with the transmission beam, and the secondary-best reception beam is one with some directional offset on the basis of the best reception beam.

Particularly, the one or more secondary-best reception beams may include multiple levels of secondary-best reception beams. Each level of secondary-best reception beam has a different directional offset. For example, there may be a second best reception beam, a third best reception beam, a fourth best reception beam, and so on. Relevant technicians may perform the configuration according to specific requirements, which is not limited specifically in the present disclosure.

In the example of the present disclosure, it determines, by the base station and based on the transmission beam notified by the second PDCCH transmitted by the base station, the transmission beam for the low power wake-up signal and transmits the low power wake-up signal according to the transmission beam, and meanwhile makes the one or more reception beams through which the terminal receives the low power wake-up signal correspond to the transmission beam, which can effectively avoid a problem of reduced reception quality of the low power wake-up signal due to a change of the transmission beam or the reception beam.

FIG. 5 is a flowchart illustrating a wake-up method in a low power mode according to an example. The method is performed by a base station. As illustrated in FIG. 5, the method includes steps S501-S502.

At S501, it is determined that a transmission beam for a low power wake-up signal is the same as a beam for transmitting a first PDSCH.

At S502, the low power wake-up signal is transmitted to a terminal according to the transmission beam.

Particularly, the first PDSCH is the last PDSCH that is received by the terminal before a main radio sleeps.

Particularly, the PDSCH may specifically refer to data carried by the PDSCH. For example, determining that the transmission beam for the low power wake-up signal is the same as the beam for transmitting the first PDSCH may specifically refer to determining that the transmission beam for the low power wake-up signal is the same as the transmission beam adopted by the base station to transmit data to the terminal through the PDSCH. The data may be the last data received by the terminal from the PDSCH before the main radio sleeps.

Correspondingly, if the base station determines the transmission beam in the scheme of step S501, the terminal may determine one or more reception beams corresponding to the transmission beam in the corresponding scheme. That is, the terminal may determine that the one or more reception beams for the low power wake-up signal correspond to the transmission beam through which the base station transmits the first PDSCH.

In an example, the one or more reception beams include at least one of the following: a best reception beam corresponding to the transmission beam; or one or more secondary-best reception beams corresponding to the transmission beam.

It is to be understood that the best reception beam is one that has the best correspondence with the transmission beam, and the secondary-best reception beam is one with some directional offset on the basis of the best reception beam.

Particularly, the one or more secondary-best reception beams may include multiple levels of secondary-best reception beams. Each level of secondary-best reception beam has a different directional offset. For example, there may be a second best reception beam, a third best reception beam, a fourth best reception beam, and so on. Relevant technicians may perform the configuration according to specific requirements, which is not limited specifically in the present disclosure.

In the example of the present disclosure, it determines, by the base station and based on the same transmission beam through which the base station transmits the first PDSCH, the transmission beam for the low power wake-up signal and transmits the low power wake-up signal according to the transmission beam, and meanwhile makes the one or more reception beams through which the terminal receives the low power wake-up signal correspond to the transmission beam, which can effectively avoid a problem of reduced reception quality of the low power wake-up signal due to a change of the transmission beam or the reception beam.

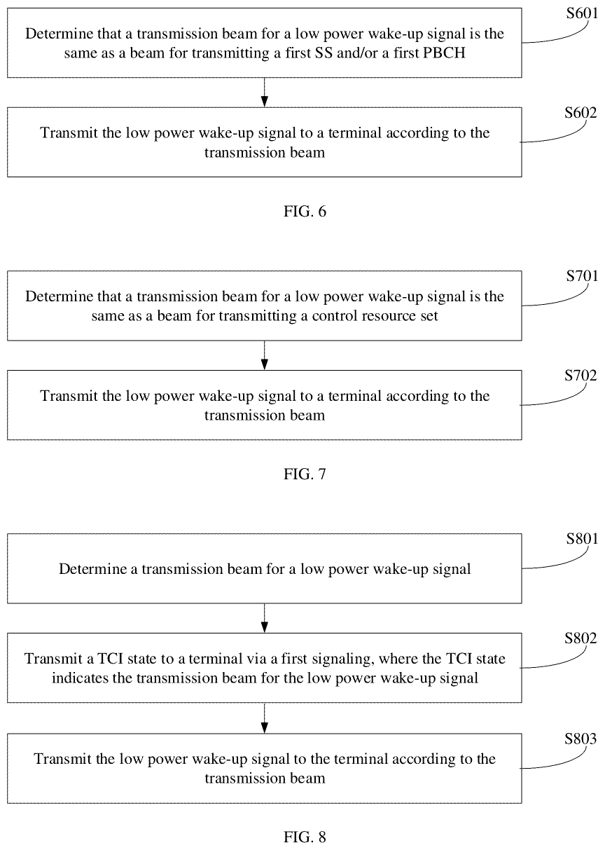

FIG. 6 is a flowchart illustrating a wake-up method in a low power mode according to an example. The method is performed by a base station. As illustrated in FIG. 6, the method includes steps S601-S602.

At S601, it is determined that a transmission beam for a low power wake-up signal is the same as a beam for transmitting a first synchronization signal (SS) and/or a first physical broadcast channel (PBCH).

At S602, the low power wake-up signal is transmitted to a terminal according to the transmission beam.

Particularly, the first SS and/or the first PBCH are an SS and/or a PBCH that are transmitted by the base station when the terminal initially accesses the base station. Alternatively, the first SS and/or the first PBCH are the last SS and/or PBCH that are received by the terminal before a main radio sleeps.

Particularly, the SS and the PBCH may be combined into a synchronization signal and physical broadcast channel block, i.e., an SS/PBCH block, which may be composed of three parts: a primary synchronization signal (PSS), a secondary synchronization signal (SSS), and a PBCH.

Correspondingly, if the base station determines the transmission beam in the scheme of step S601, the terminal may determine one or more reception beams corresponding to the transmission beam in the corresponding scheme. For example, the terminal may determine that the one or more reception beams for the low power wake-up signal correspond to the transmission beam through which the base station transmits the first SS and/or the first PBCH.

In an example, the one or more reception beams include at least one of the following: a best reception beam corresponding to the transmission beam; or one or more secondary-best reception beams corresponding to the transmission beam.

It is to be understood that the best reception beam is one that has the best correspondence with the transmission beam, and the secondary-best reception beam is one with some directional offset on the basis of the best reception beam.

Particularly, the one or more secondary-best reception beams may include multiple levels of secondary-best reception beams. Each level of secondary-best reception beam has a different directional offset. For example, there may be a second best reception beam, a third best reception beam, a fourth best reception beam, and so on. Relevant technicians may perform the configuration according to specific requirements, which is not limited specifically in the present disclosure.

In the example of the present disclosure, it determines, by the base station and based on the same transmission beam through which the base station transmits the first SS and/or the first PBCH, the transmission beam for the low power wake-up signal and transmits the low power wake-up signal according to the transmission beam, and meanwhile makes the one or more reception beams through which the terminal receives the low power wake-up signal correspond to the transmission beam, which can effectively avoid a problem of reduced reception quality of the low power wake-up signal due to a change of the transmission beam or the reception beam.

FIG. 7 is a flowchart illustrating a wake-up method in a low power mode according to an example. The method is performed by a base station. As illustrated in FIG. 7, the method includes steps S701-S702.

At S701, it is determined that a transmission beam for a low power wake-up signal is the same as a beam for transmitting a control resource set.

At S702, the low power wake-up signal is transmitted to a terminal according to the transmission beam.

It is worth noting that the control resource set may specifically refer to a scheduling block in a system information block (SIB) parsed by the terminal during an initial access process, i.e., PDCCH information required by SIB1. The control resource set may specifically be CORESET0, also known as Type0-PDCCH.

Correspondingly, if the base station determines the transmission beam in the scheme of step S701, the terminal may determine one or more reception beams corresponding to the transmission beam in the corresponding scheme. For example, the terminal may determine that the one or more reception beams for the low power wake-up signal correspond to the transmission beam through which the base station transmits the control resource set.

In an example, the one or more reception beams include at least one of the following: a best reception beam corresponding to the transmission beam; or one or more secondary-best reception beams corresponding to the transmission beam.

It is to be understood that the best reception beam is one that has the best correspondence with the transmission beam, and the secondary-best reception beam is one with some directional offset on the basis of the best reception beam.

Particularly, the one or more secondary-best reception beams may include multiple levels of secondary-best reception beams. Each level of secondary-best reception beam has a different directional offset. For example, there may be a second best reception beam, a third best reception beam, a fourth best reception beam, and so on. Relevant technicians may perform the configuration according to specific requirements, which is not limited specifically in the present disclosure.

In the example of the present disclosure, it determines, by the base station and based on the same transmission beam through which the base station transmits the control resource set, the transmission beam for the low power wake-up signal and transmits the low power wake-up signal according to the transmission beam, and meanwhile makes the one or more reception beams through which the terminal receives the low power wake-up signal correspond to the transmission beam, which can effectively avoid a problem of reduced reception quality of the low power wake-up signal due to a change of the transmission beam or the reception beam.

FIG. 8 is a flowchart illustrating a wake-up method in a low power mode according to an example. The method is performed by a base station. As illustrated in FIG. 8, the method includes steps S801-S803.

At S801, a transmission beam for a low power wake-up signal is determined.

At S802, a transmission configuration indication state (TCI state) is transmitted to a terminal via a first signaling, where the transmission configuration indication state indicates the transmission beam for the low power wake-up signal.

At S803, the low power wake-up signal is transmitted to the terminal according to the transmission beam.

Particularly, the first signaling includes at least one of the following: a radio resource control (RRC) signaling, a media access control control element (MAC CE), and DCI.

Specifically, the transmission configuration indication state may be carried by only one of the RRC signaling, the MAC CE or the DCI. Alternatively, parts of the information may be carried by multiple signalings separately. For example, for the transmission configuration indication state, one part of the information may be carried by the RRC signaling and another part of the information may be carried by the MAC CE.

In step S801, the base station may determine an arbitrary transmission beam, further transmit the low power wake-up signal through the transmission beam, and indicate the determined transmission beam to the terminal via step S802. Correspondingly, the terminal may determine one or more reception beams corresponding to the transmission beam based on the transmission beam indicated by the transmission configuration indication state in the first signaling, and then receive the low power wake-up signal according to the one or more reception beams.

In an example, the one or more reception beams include at least one of the following: a best reception beam corresponding to the transmission beam; or one or more secondary-best reception beams corresponding to the transmission beam.

It is to be understood that the best reception beam is one that has the best correspondence with the transmission beam, and the secondary-best reception beam is one with some directional offset on the basis of the best reception beam.

Particularly, the one or more secondary-best reception beams may include multiple levels of secondary-best reception beams. Each level of secondary-best reception beam has a different directional offset. For example, there may be a second best reception beam, a third best reception beam, a fourth best reception beam, and so on. Relevant technicians may perform the configuration according to specific requirements, which is not limited specifically in the present disclosure.

In the example of the present disclosure, it determines by the base station the transmission beam for the low power wake-up signal and transmits the low power wake-up signal according to the transmission beam, and meanwhile transmits the transmission configuration indication state via the first signaling to indicate the terminal the transmission beam adopted by the base station, so that the one or more reception beams through which the terminal receives the low power wake-up signal correspond to the transmission beam, which can effectively avoid a problem of reduced reception quality of the low power wake-up signal due to a change of the transmission beam or the reception beam.

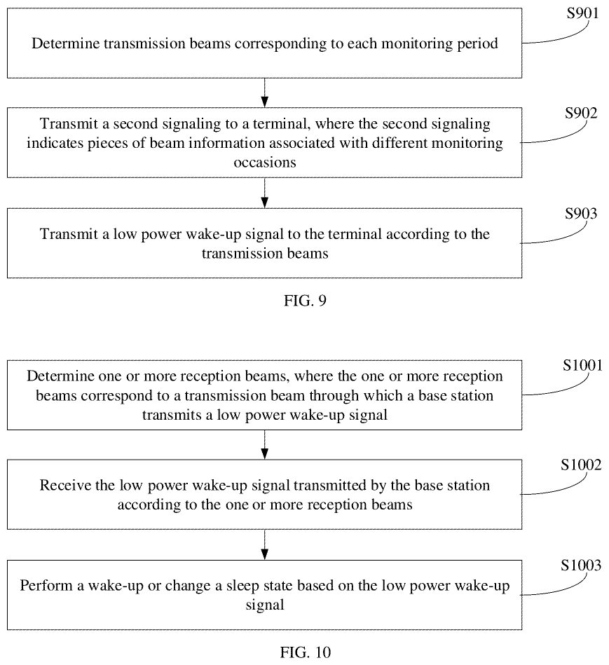

FIG. 9 is a flowchart illustrating a wake-up method in a low power mode according to an example. The method is performed by a base station. As illustrated in FIG. 9, the method includes steps S901-S903.

At S901, transmission beams corresponding to each monitoring period are determined.

At S902, a second signaling is transmitted to a terminal, where the second signaling indicates pieces of beam information associated with different monitoring occasions.

Particularly, the pieces of beam information correspond to the transmission beams used at the monitoring occasions associated with the pieces of beam information. At S903, a low power wake-up signal is transmitted to the terminal according to the transmission beams.

In an example, the second signaling includes at least one of the following: an RRC signaling, an MAC CE, or DCI.

Specifically, the pieces of beam information associated with the different monitoring occasions may be carried by only one of the RRC signaling, the MAC CE or the DCI. Alternatively, parts of the pieces of beam information may be carried by multiple signalings separately. For example, for the pieces of beam information associated with the different monitoring occasions, one part of the pieces of information may be carried by the RRC signaling and another part of the pieces of information may be carried by the MAC CE.

In addition, the base station may transmit the low power wake-up signal using different transmission beams in different directions at a certain period. There may be multiple transmission occasions in the period, and accordingly, each transmission occasion may correspond to one monitoring occasion of the terminal. The terminal may adopt different reception beams corresponding to different monitoring occasions in one period. Correspondingly, the base station may adopt different transmission beams to transmit the low power wake-up signal at different transmission occasions in one period.

It is to be understood that the terminal monitors the low power wake-up signal according to the transmission beams represented by the pieces of beam information. Specifically, the terminal may first determine the transmission beam corresponding to the piece of beam information based on the piece of beam information of each monitoring occasion, then determine one or more reception beams corresponding to the transmission beam at each monitoring occasion, and receive the low power wake-up signal according to the one or more reception beams corresponding to each monitoring occasion, so that monitoring the low power wake-up signal is achieved.

In an example, the one or more reception beams include at least one of the following: a best reception beam corresponding to the transmission beam; or one or more secondary-best reception beams corresponding to the transmission beam.

It is to be understood that the best reception beam is one that has the best correspondence with the transmission beam, and the secondary-best reception beam is one with some directional offset on the basis of the best reception beam.

Particularly, the one or more secondary-best reception beams may include multiple levels of secondary-best reception beams. Each level of secondary-best reception beam has a different directional offset. For example, there may be a second best reception beam, a third best reception beam, a fourth best reception beam, and so on. Relevant technicians may perform the configuration according to specific requirements, which is not limited specifically in the present disclosure.

In another example, the second signaling includes at least one of the following: a beam cycle period, which is a count of monitoring occasions associated with different beam information, with the count being an integer greater than or equal to 2; a beam information field, which includes at least one piece of beam information; a beam association indication field, which indicates a piece of beam information associated with each monitoring occasion; or indication information about being associated in a default mode, where the indication information indicates that the monitoring occasions in the beam cycle period are associated with the beam information in the beam information field.

Particularly, the count of the pieces of beam information included in the beam information field may be the same as or different from the count of the monitoring occasions in the beam cycle period, which is not specifically limited in the present disclosure.

For example, if the beam cycle period includes 5 monitoring occasions and each monitoring occasion may be associated with one transmission beam, the base station may transmit, at the transmission occasion corresponding to each monitoring occasion, the low power wake-up signal according to the transmission beam associated with the monitoring occasion. The terminal may receive, at each monitoring occasion, the low power wake-up signal according to the one or more reception beams corresponding to the transmission beam associated with the monitoring occasion. Particularly, the transmission beam associated with each monitoring occasion may be included in the beam information field.

Particularly, the base station may first determine the transmission beam for transmitting the low power wake-up signal at each transmission occasion, and accordingly, associate the monitoring occasion corresponding to each transmission occasion with the beam information of the transmission beam to obtain the beam association indication field, so that the terminal can determine the one or more reception beams adopted at each monitoring occasion based on the beam association indication field.

In addition, after determining the transmission beam for transmitting the low power wake-up signal at each transmission occasion, the base station may send to the terminal various monitoring occasions in a certain order, transmission beams corresponding to various monitoring occasions, and the indication information that indicates the terminal to associate in the default mode, so that the terminal performs management in the default mode, that is, the terminal determines the one or more reception beams adopted at each monitoring occasion in accordance with the order of the monitoring occasions and the pieces of beam information.

In a possible implementation, if including no beam association indication field, the second signaling may indicate the terminal to perform an association in the default mode. That is to say, if the second signaling does not include the beam association indication field, it may be considered that the second signaling includes indication information of performing the association in the default mode.

In the example of the present disclosure, it determines by the base station the transmission beams for the low power wake-up signal at each monitoring period and transmits the low power wake-up signal according to the transmission beam, and meanwhile indicates the pieces of beam information of the transmission beams of the base station at each monitoring period using the second signaling, so that the terminal further determines the one or more reception beams adopted at each monitoring occasion to receive the low power wake-up signal, which can effectively avoid a problem of reduced reception quality of the low power wake-up signal due to a change of the transmission beam or the reception beam.

FIG. 10 is a flowchart illustrating a wake-up method in a low power mode according to an example. The method is performed by a terminal. As illustrated in FIG. 10, the method includes steps S1001-S1003.

At S1001, one or more reception beams are determined, where the one or more reception beams correspond to a transmission beam through which a base station transmits a low power wake-up signal.

At S1002, the low power wake-up signal transmitted by the base station is received according to the one or more reception beams.

At S1003, a wake-up is performed or a sleep state is changed based on the low power wake-up signal.

For example, in step S1002, the terminal performs the wake-up or change the sleep state in response to the low power wake-up signal, which may include switching from an ultra-deep sleep to a deep sleep, or switching from a micro sleep to a light sleep, or switching from a deep sleep to a wake-up state, etc. The specific mode to be switched from or to be switched to may be determined based on the terminal's own capabilities, the current sleep state, and the low power wake-up signal.

Particularly, the terminal may adopt the one or more reception beams determined in different schemes in step S1001, and correspondingly, the base station may adopt the corresponding scheme to determine the transmission beam, so that the one or more reception beams through which the terminal receives the low power wake-up signal correspond to the transmission beam determined by the base station.

For example, the base station and the terminal may be uniformly configured to determine the transmission beam and the one or more reception beams in the corresponding beam determination scheme, respectively, so that the transmission beam and the one or more reception beams correspond to each other. Alternatively, the base station may indicate information related to the transmission beam to the terminal, so that the transmission beam of the base station corresponds to the one or more reception beams of the terminal. What beam determination scheme that the base station and the terminal adopt specifically is to be described in detail in the following examples and is not repeated here.

In an example, the one or more reception beams include at least one of the following: a best reception beam corresponding to the transmission beam; or one or more secondary-best reception beams corresponding to the transmission beam.

It is to be understood that the best reception beam is one that has the best correspondence with the transmission beam. The secondary-best reception beam is one with some directional offset on the basis of the best reception beam, which avoids a problem that the best reception beam cannot reliably receive the low power wake-up signal due to some directional offset of the transmission beam.

Particularly, the one or more secondary-best reception beams may include multiple levels of secondary-best reception beams. Each level of secondary-best reception beam has a different directional offset. For example, there may be a second best reception beam, a third best reception beam, a fourth best reception beam, and so on. Relevant technicians may perform the configuration according to specific requirements, which is not limited specifically in the present disclosure.

In the example of the present disclosure, it determines by the base station the transmission beam for the low power wake-up signal and transmits the low power wake-up signal according to the transmission beam, and meanwhile makes the one or more reception beams through which the terminal receives the low power wake-up signal correspond to the transmission beam, which can effectively avoid a problem of reduced reception quality of the low power wake-up signal due to a change of the transmission beam or the reception beam.

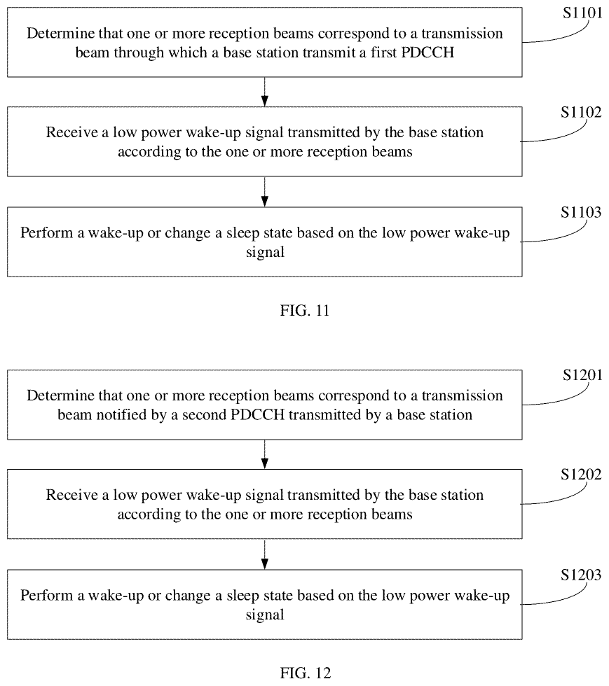

FIG. 11 is a flowchart illustrating a wake-up method in a low power mode according to an example. The method is performed by a terminal. As illustrated in FIG. 11, the method includes steps S1101-S1103.

At S1101, it is determined that one or more reception beams correspond to a transmission beam through which a base station transmit a first PDCCH.

At S1102, a low power wake-up signal transmitted by the base station is received according to the one or more reception beams.

At S1103, a wake-up is performed or a sleep state is changed based on the low power wake-up signal.

Particularly, the first PDCCH carries the last DCI that is received by the terminal before a main radio sleeps, or the first PDCCH is the last PDCCH that is received by the terminal before the main radio sleeps, or the first PDCCH schedules the last PDSCH that is received before the terminal sleeps, or the first PDCCH schedules a PDSCH for the last HARQ feedback before the terminal sleeps.

Correspondingly, if the terminal determines the one or more reception beams in the scheme of step S1101, the base station may determine a transmission beam corresponding to the one or more reception beams in the corresponding scheme. For example, if the terminal determines that the one or more reception beams for the low power wake-up signal correspond to the transmission beam for the PDCCH carrying the last DCI that is received by the terminal before the main radio sleeps, the base station may determine the same transmission beam for the low power wake-up signal based on the transmission beam for the PDCCH. If the terminal determines that the one or more reception beams for the low power wake-up signal corresponds to the transmission beam for the last PDCCH that is received by the terminal before the main radio sleeps, the base station may determine the same transmission beam for the low power wake-up signal based on the transmission beam for the PDCCH.

In an example, the one or more reception beams include at least one of the following: a best reception beam corresponding to the transmission beam; or one or more secondary-best reception beams corresponding to the transmission beam.

It is to be understood that the best reception beam is one that has the best correspondence with the transmission beam, and the secondary-best reception beam is one with some directional offset on the basis of the best reception beam.

Particularly, the one or more secondary-best reception beams may include multiple levels of secondary-best reception beams. Each level of secondary-best reception beam has a different directional offset. For example, there may be a second best reception beam, a third best reception beam, a fourth best reception beam, and so on. Relevant technicians may perform the configuration according to specific requirements, which is not limited specifically in the present disclosure.

In the example of the present disclosure, it determines, by the terminal and based on the transmission beam adopted for the first PDCCH transmitted by the base station, the one or more reception beams for the low power wake-up signal and receives the low power wake-up signal according to the one or more reception beams, and meanwhile makes the transmission beam through which the base station transmits the low power wake-up signal correspond to the one or more reception beams, which can effectively avoid a problem of reduced reception quality of the low power wake-up signal due to a change of the transmission beam or the reception beam.

FIG. 12 is a flowchart illustrating a wake-up method in a low power mode according to an example. The method is performed by a terminal. As illustrated in FIG. 12, the method includes steps S1201-S1203.

At S1201, it is determined that one or more reception beams correspond to a transmission beam notified by a second PDCCH transmitted by a base station.

At S1202, a low power wake-up signal transmitted by the base station is received according to the one or more reception beams.

At S1203, a wake-up is performed or a sleep state is changed based on the low power wake-up signal.

Particularly, the second PDCCH carries the last DCI that is received by the terminal before a main radio sleeps, or the second PDCCH is the last PDCCH that is received by the terminal before the main radio sleeps, or the second PDCCH schedules the last PDSCH that is received before the terminal sleeps.

Correspondingly, if the terminal determines the one or more reception beams in the scheme of step S1201, the base station may determine a transmission beam corresponding to the one or more reception beams in the corresponding scheme. For example, the base station may determine that the transmission beam through which it transmits the low power wake-up signal is the same as the transmission beam for the low power wake-up signal notified by the second PDCCH.

In an example, the one or more reception beams include at least one of the following: a best reception beam corresponding to the transmission beam; or one or more secondary-best reception beams corresponding to the transmission beam.

It is to be understood that the best reception beam is one that has the best correspondence with the transmission beam, and the secondary-best reception beam is one with some directional offset on the basis of the best reception beam.

Particularly, the one or more secondary-best reception beams may include multiple levels of secondary-best reception beams. Each level of secondary-best reception beam has a different directional offset. For example, there may be a second best reception beam, a third best reception beam, a fourth best reception beam, and so on. Relevant technicians may perform the configuration according to specific requirements, which is not limited specifically in the present disclosure.

In the example of the present disclosure, it determines, by the terminal and based on the transmission beam notified by the second PDCCH that is transmitted by the base station, the one or more reception beams for the low power wake-up signal and receives the low power wake-up signal according to the one or more reception beams, and meanwhile makes the transmission beam, through which the base station transmits the low power wake-up signal, the same as the transmission beam, which can effectively avoid a problem of reduced reception quality of the low power wake-up signal due to a change of the transmission beam or the reception beam.

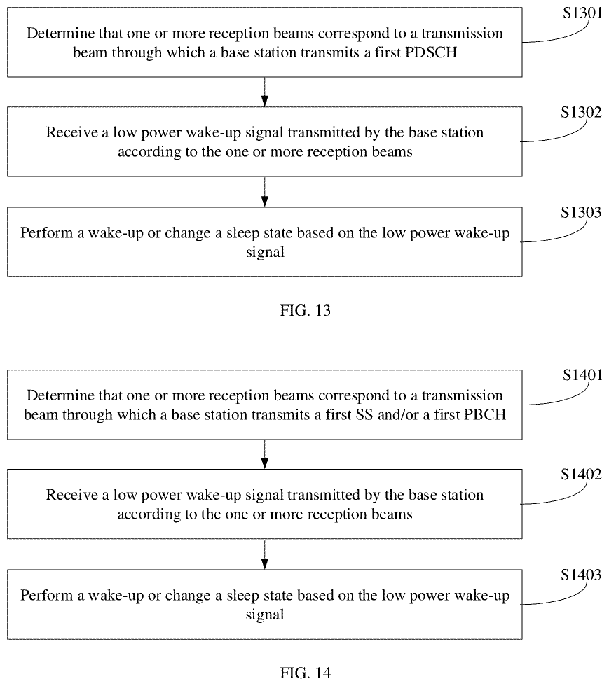

FIG. 13 is a flowchart illustrating a wake-up method in a low power mode according to an example. The method is performed by a terminal. As illustrated in FIG. 13, the method includes steps S1301-S1303.

At S1301, it is determined that one or more reception beams correspond to a transmission beam through which a base station transmits a first PDSCH.

At S1302, a low power wake-up signal transmitted by the base station is received according to the one or more reception beams.

At S1303, a wake-up is performed or a sleep state is changed based on the low power wake-up signal.

Particularly, the first PDSCH is the last PDSCH that is received by the terminal before a main radio sleeps.

Correspondingly, if the terminal determines the one or more reception beams in the scheme of step S1301, the base station may determine a transmission beam corresponding to the one or more reception beams in the corresponding scheme. For example, the base station may determine that the transmission beam through which it transmits the low power wake-up signal is the same as the transmission beam for the first PDSCH.

In an example, the one or more reception beams include at least one of the following: a best reception beam corresponding to the transmission beam; or one or more secondary-best reception beams corresponding to the transmission beam.

It is to be understood that the best reception beam is one that has the best correspondence with the transmission beam, and the secondary-best reception beam is one with some directional offset on the basis of the best reception beam.

Particularly, the one or more secondary-best reception beams may include multiple levels of secondary-best reception beams. Each level of secondary-best reception beam has a different directional offset. For example, there may be a second best reception beam, a third best reception beam, a fourth best reception beam, and so on. Relevant technicians may perform the configuration according to specific requirements, which is not limited specifically in the present disclosure.

In the example of the present disclosure, it determines, by the terminal and based on the transmission beam through which the base station transmits the first PDSCH, the one or more reception beams for the low power wake-up signal and receives the low power wake-up signal according to the one or more reception beams, and meanwhile makes the transmission beam, through which the base station transmits the low power wake-up signal, the same as the transmission beam for the first PDSCH, which can effectively avoid a problem of reduced reception quality of the low power wake-up signal due to a change of the transmission beam or the reception beam.

FIG. 14 is a flowchart illustrating a wake-up method in a low power mode according to an example. The method is performed by a terminal. As illustrated in FIG. 14, the method includes steps S1401-S1403.

At S1401, it is determined that one or more reception beams correspond to a transmission beam through which a base station transmits a first SS and/or a first PBCH.

Particularly, the first SS and/or the first PBCH are an SS and/or a PBCH that are transmitted by the base station when the terminal initially accesses the base station. Alternatively, the first SS and/or the first PBCH are the last SS and/or PBCH that are received by the terminal before a main radio sleeps.

At S1402, a low power wake-up signal transmitted by the base station is received according to the one or more reception beams.

At S1403, a wake-up is performed or a sleep state is changed based on the low power wake-up signal.

Correspondingly, if the terminal determines the one or more reception beams in the scheme of step S1401, the base station may determine a transmission beam corresponding to the one or more reception beams in the corresponding scheme. For example, the base station may determine that the transmission beam through which it transmits the low power wake-up signal is the same as the transmission beam for the first SS and/or the first PBCH.

In an example, the one or more reception beams include at least one of the following: a best reception beam corresponding to the transmission beam; or one or more secondary-best reception beams corresponding to the transmission beam.

It is to be understood that the best reception beam is one that has the best correspondence with the transmission beam, and the secondary-best reception beam is one with some directional offset on the basis of the best reception beam.

Particularly, the one or more secondary-best reception beams may include multiple levels of secondary-best reception beams. Each level of secondary-best reception beam has a different directional offset. For example, there may be a second best reception beam, a third best reception beam, a fourth best reception beam, and so on. Relevant technicians may perform the configuration according to specific requirements, which is not limited specifically in the present disclosure.

In the example of the present disclosure, it determines, by the terminal and based on the transmission beam through which the base station transmits the first SS and/or the first PBCH, the one or more reception beams for the low power wake-up signal and receives the low power wake-up signal according to the one or more reception beams, and meanwhile makes the transmission beam through which the base station transmits the low power wake-up signal is the same as the transmission beam for the first SS and/or the first PBCH, which can effectively avoid a problem of reduced reception quality of the low power wake-up signal due to a change of the transmission beam or the reception beam.

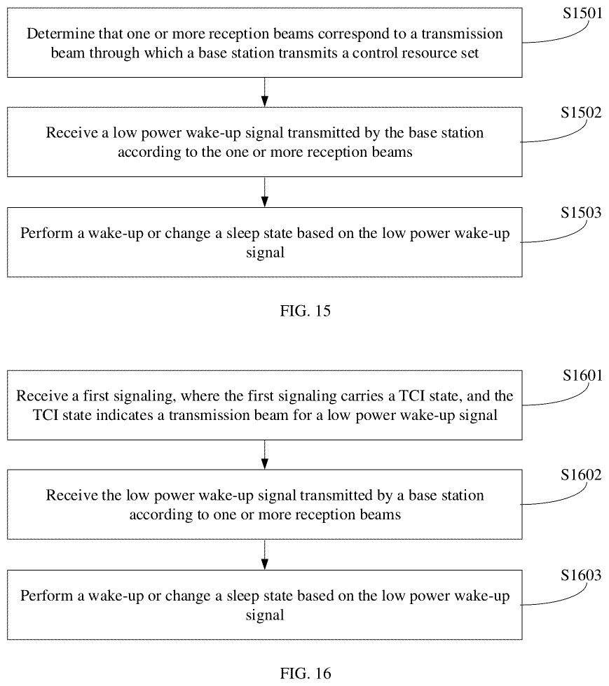

FIG. 15 is a flowchart illustrating a wake-up method in a low power mode according to an example. The method is performed by a terminal. As illustrated in FIG. 15, the method includes steps S1501-S1503.

At S1501, it is determined that one or more reception beams correspond to a transmission beam through which a base station transmits a control resource set.

At S1502, a low power wake-up signal transmitted by the base station is received according to the one or more reception beams.

At S1503, a wake-up is performed or a sleep state is changed based on the low power wake-up signal.

Correspondingly, if the terminal determines the one or more reception beams in the scheme of step S1501, the base station may determine a transmission beam corresponding to the one or more reception beams in the corresponding scheme. For example, the base station may determine that the transmission beam through which it transmits the low power wake-up signal is the same as the transmission beam for the target control resources.

In an example, the one or more reception beams include at least one of the following: a best reception beam corresponding to the transmission beam; or one or more secondary-best reception beams corresponding to the transmission beam.

It is to be understood that the best reception beam is one that has the best correspondence with the transmission beam, and the secondary-best reception beam is one with some directional offset on the basis of the best reception beam.

Particularly, the one or more secondary-best reception beams may include multiple levels of secondary-best reception beams. Each level of secondary-best reception beam has a different directional offset. For example, there may be a second best reception beam, a third best reception beam, a fourth best reception beam, and so on. Relevant technicians may perform the configuration according to specific requirements, which is not limited specifically in the present disclosure.

In the example of the present disclosure, it determines, by the terminal and based on the transmission beam through which the base station transmits the target control resources, the one or more reception beams for the low power wake-up signal and receives the low power wake-up signal according to the one or more reception beams, and meanwhile makes the transmission beam through which the base station transmits the low power wake-up signal is the same as the transmission beam for the target control resources, which can effectively avoid a problem of reduced reception quality of the low power wake-up signal due to a change of the transmission beam or the reception beam.

FIG. 16 is a flowchart illustrating a wake-up method in a low power mode according to an example. The method is performed by a terminal. As illustrated in FIG. 16, the method includes steps S1601-S1603.

At S1601, a first signaling is received, where the first signaling carries a TCI state, and the TCI state indicates a transmission beam for a low power wake-up signal.

Particularly, the first signaling includes at least one of the following: an RRC signaling, an MAC CE, or DCI.

At S1602, the low power wake-up signal transmitted by a base station is received according to one or more reception beams.

At S1603, a wake-up is performed or a sleep state is changed based on the low power wake-up signal.

Specifically, the transmission configuration indication state may be carried by only one of the RRC signaling, the MAC CE or the DCI. Alternatively, parts of the information may be carried by multiple signalings separately. For example, for the transmission configuration indication state, one part of the information may be carried by the RRC signaling and another part of the information may be carried by the MAC CE.

Particularly, the base station may determine an arbitrary transmission beam, further transmit the low power wake-up signal through the transmission beam, and indicate the determined transmission beam to the terminal via the first signaling. Correspondingly, the terminal may determine the one or more reception beams corresponding to the transmission beam based on the transmission beam indicated by the transmission configuration indication state in the first signaling, and then receive the low power wake-up signal according to the one or more reception beams.

In an example, the one or more reception beams include at least one of the following: a best reception beam corresponding to the transmission beam; or one or more secondary-best reception beams corresponding to the transmission beam.

It is to be understood that the best reception beam is one that has the best correspondence with the transmission beam, and the secondary-best reception beam is one with some directional offset on the basis of the best reception beam.

Particularly, the one or more secondary-best reception beams may include multiple levels of secondary-best reception beams. Each level of secondary-best reception beam has a different directional offset. For example, there may be a second best reception beam, a third best reception beam, a fourth best reception beam, and so on. Relevant technicians may perform the configuration according to specific requirements, which is not limited specifically in the present disclosure.

In the example of the present disclosure, it determines by the base station the transmission beam for the low power wake-up signal and transmits the low power wake-up signal according to the transmission beam, and meanwhile transmits the TCI state via the first signaling to indicate the terminal the transmission beam adopted by the base station, so that the one or more reception beams through which the terminal receives the low power wake-up signal correspond to the transmission beam, which can effectively avoid a problem of reduced reception quality of the low power wake-up signal due to a change of the transmission beam or the reception beam.

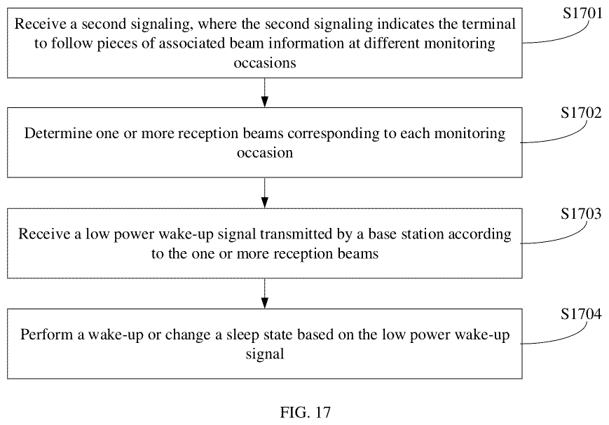

FIG. 17 is a flowchart illustrating a wake-up method in a low power mode according to an example. The method is performed by a terminal. As illustrated in FIG. 17, the method includes steps S1701-S1704.

At S1701, a second signaling is received, where the second signaling indicates the terminal to follow pieces of associated beam information at different monitoring occasions.

At S1702, one or more reception beams corresponding to each monitoring occasion are determined.

At S1703, a low power wake-up signal transmitted by a base station is received according to the one or more reception beams.

At S1704, a wake-up is performed or a sleep state is changed based on the low power wake-up signal.

In an example, the second signaling includes at least one of the following: an RRC signaling, an MAC CE, or DCI.

Specifically, the pieces of beam information associated with the different monitoring occasions may be carried by only one of the RRC signaling, the MAC CE or the DCI. Alternatively, parts of the pieces of information may be carried by multiple signalings separately. For example, for the pieces of beam information associated with the different monitoring occasions, one part of the pieces of information may be carried by the RRC signaling and another part of the pieces of information may be carried by the MAC CE.

In addition, the base station may transmit the low power wake-up signal using different transmission beams in different directions at a certain period. There may be multiple transmission occasions in the period, and accordingly, each transmission occasion may correspond to one monitoring occasion of the terminal. The terminal may adopt different reception beams corresponding to different monitoring occasions in one period. Correspondingly, the base station may adopt different transmission beams to transmit the low power wake-up signal at different transmission occasions in one period.

It is to be understood that the terminal monitors the low power wake-up signal according to the transmission beams represented by the pieces of beam information. Specifically, the terminal may first determine the transmission beam corresponding to the piece of beam information based on the piece of beam information of each monitoring occasion, then determine the one or more reception beams corresponding to the transmission beam at each monitoring occasion, and receive the low power wake-up signal according to the one or more reception beams corresponding to each monitoring occasion, so that monitoring the low power wake-up signal is achieved.

In an example, the one or more reception beams include at least one of the following: a best reception beam corresponding to the transmission beam; or one or more secondary-best reception beams corresponding to the transmission beam.

It is to be understood that the best reception beam is one that has the best correspondence with the transmission beam, and the secondary-best reception beam is one with some directional offset on the basis of the best reception beam.

Particularly, the one or more secondary-best reception beams may include multiple levels of secondary-best reception beams. Each level of secondary-best reception beam has a different directional offset. For example, there may be a second best reception beam, a third best reception beam, a fourth best reception beam, and so on. Relevant technicians may perform the configuration according to specific requirements, which is not limited specifically in the present disclosure.

In another example, the second signaling includes at least one of the following: a beam cycle period, which is a count of monitoring occasions associated with different beam information, with the count being an integer greater than or equal to 2; a beam information field, which includes at least one piece of beam information; a beam association indication field, which indicates a piece of beam information associated with each monitoring occasion; or indication information about being associated in a default mode, where the indication information indicates that the monitoring occasions in the beam cycle period are associated with the beam information in the beam information field.

Particularly, the count of the pieces of beam information included in the beam information field may be the same as or different from the count of the monitoring occasions in the beam cycle period, which is not specifically limited in the present disclosure.

For example, if the beam cycle period includes 5 monitoring occasions and each monitoring occasion may be associated with one transmission beam, the base station may transmit, at the transmission occasion corresponding to each monitoring occasion, the low power wake-up signal according to the transmission beam associated with the monitoring occasion. The terminal may receive, at each monitoring occasion, the low power wake-up signal according to the one or more reception beams corresponding to the transmission beam associated with the monitoring occasion. Particularly, the transmission beam associated with each monitoring occasion may be included in the beam information field.

Particularly, the base station may first determine the transmission beam for transmitting the low power wake-up signal at each transmission occasion, and accordingly, associate the monitoring occasion corresponding to each transmission occasion with the beam information of the transmission beam to obtain the beam association indication field, so that the terminal can determine the one or more reception beams adopted at each monitoring occasion based on the beam association indication field.

In addition, after determining the transmission beam for transmitting the low power wake-up signal at each transmission occasion, the base station may send to the terminal various monitoring occasions in a certain order, transmission beams corresponding to various monitoring occasions, and the indication information that indicates the terminal to associate in the default mode, so that the terminal performs management in the default mode, that is, the terminal determines the one or more reception beams adopted at each monitoring occasion in accordance with the order of the monitoring occasions and the pieces of beam information.

In a possible implementation, if including no beam association indication field, the second signaling may indicate the terminal to perform an association in the default mode. That is to say, if the second signaling does not include the beam association indication field, it may be considered that the second signaling includes indication information of performing the association in the default mode.

In the example of the present disclosure, it determines by the base station the transmission beams for the low power wake-up signal at each monitoring period and transmits the low power wake-up signal according to the transmission beam, and meanwhile indicates the pieces of beam information of the transmission beams of the base station at each monitoring period using the second signaling, so that the terminal further determines the one or more reception beams adopted at each monitoring occasion to receive the low power wake-up signal, which can effectively avoid a problem of reduced reception quality of the low power wake-up signal due to a change of the transmission beam or the reception beam.

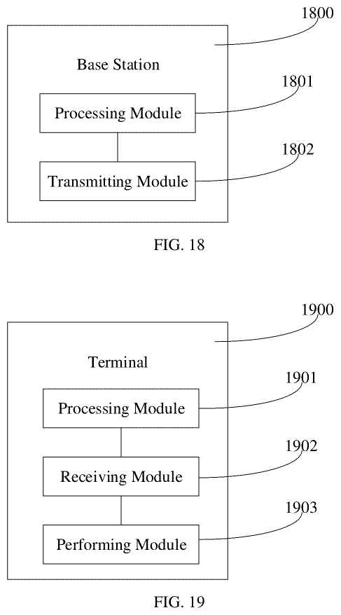

FIG. 18 is a block diagram illustrating a base station according to an example. As illustrated in FIG. 18, the base station 1800 includes a processing module 1801 and a transmitting module 1802.

The processing module 1801 is configured to determine a transmission beam for a low power wake-up signal, where one or more reception beams for receiving the low power wake-up signal by a terminal correspond to the transmission beam.

The transmitting module 1802 is configured to transmit the low power wake-up signal to the terminal according to the transmission beam.

Alternatively, or additionally, the processing module 1801 is configured to: determine that the transmission beam is the same as a beam for transmitting a first PDCCH.

Particularly, the first PDCCH carries the last DCI that is received by the terminal before a main radio sleeps, or the first PDCCH is the last PDCCH that is received by the terminal before the main radio sleeps, or the first PDCCH schedules the last PDSCH that is received before the terminal sleeps, or the first PDCCH schedules a PDSCH for the last HARQ feedback before the terminal sleeps.

Alternatively, or additionally, the processing module 1801 is configured to: determine that the transmission beam is the same as a beam indicated by a second PDCCH.

Particularly, the second PDCCH carries the last DCI that is received by the terminal before the main radio sleeps. Alternatively, the second PDCCH is the last PDCCH that is received by the terminal before the main radio sleeps.

Alternatively, or additionally, the processing module 1801 is configured to: determine that the transmission beam is the same as a beam for transmitting a PDSCH.

Particularly, the first PDSCH is the last PDSCH that is received by the terminal before the main radio sleeps.

Alternatively, or additionally, the processing module 1801 is configured to: determine that the transmission beam is the same as a beam for transmitting a first SS and/or a first PBCH.

Particularly, the first SS and/or the first PBCH are an SS and/or a PBCH that are transmitted by the base station when the terminal initially accesses the base station. Alternatively, the first SS and/or the first PBCH are the last SS and/or PBCH that are received by the terminal before the main radio sleeps.

Alternatively, or additionally, the processing module 1801 is configured to: determine that the transmission beam is the same as a beam for transmitting a control resource set.

Alternatively, or additionally, the base station 1800 includes: a first transmitting module that is configured to transmit a transmission configuration indication state to the terminal via a first signaling. The transmission configuration indication state indicates the transmission beam for the low power wake-up signal.

Particularly, the first signaling includes at least one of the following: an RRC signaling, an MAC CE, or DCI.

Alternatively, or additionally, the processing module 1801 is configured to: determine transmission beams corresponding to each monitoring period.

The base station 1800 includes: a second transmitting module that is configured to transmit a second signaling to the terminal. The second signaling indicates pieces of beam information associated with different monitoring occasions.

Particularly, the pieces of beam information correspond to the transmission beams used at the monitoring occasions associated with the pieces of beam information.

Alternatively, or additionally, the second signaling includes at least one of the following: an RRC signaling, an MAC CE, or DCI.

Alternatively, or additionally, the second signaling further includes at least one of the following: a beam cycle period, which is a count of the monitoring occasions associated with different beam information, and the count is an integer greater than or equal to 2; a beam information field, which includes at least one piece of beam information; a beam association indication field, which indicates a piece of beam information associated with each monitoring occasion; or, indication information about being associated in a default mode, where the indication information indicates that the monitoring occasions in the beam cycle period are associated with the beam information in the beam information field.

FIG. 19 is a block diagram illustrating a terminal according to an example. As illustrated in FIG. 19, the terminal 1900 includes a processing module 1901, a receiving module 1902 and a performing module 1903.

The processing module 1901 is configured to determine one or more reception beams, where the one or more reception beams correspond to a transmission beam through which a base station transmits a low power wake-up signal.

The receiving module 1902 is configured to receive, according to the one or more reception beams, the low power wake-up signal transmitted by the base station.

The performing module 1903 is configured to perform a wake-up or change a sleep state based on the low power wake-up signal.

Alternatively, or additionally, the processing module 1901 is configured to: determine that the one or more reception beams correspond to a transmission beam through which the base station transmits a first PDCCH.

Particularly, the first PDCCH carries the last DCI that is received by the terminal before a main radio sleeps, or the first PDCCH is the last PDCCH that is received by the terminal before the main radio sleeps, or the first PDCCH schedules the last PDSCH that is received before the terminal sleeps, or the first PDCCH schedules a PDSCH for the last HARQ feedback before the terminal sleeps.

Alternatively, or additionally, the processing module 1901 is configured to: determine that the one or more reception beams correspond to a transmission beam indicated by a second PDCCH transmitted by the base station.

Particularly, the second PDCCH carries the last DCI that is received by the terminal before the main radio sleeps, or the second PDCCH is the last PDCCH that is received by the terminal before the main radio sleeps.

Alternatively, or additionally, the processing module 1901 is configured to: determine that the one or more reception beams correspond to a transmission beam through which the base station transmits a first PDSCH.

Particularly, the first PDSCH is the last PDSCH that is received by the terminal before the main radio sleeps.

Alternatively, or additionally, the processing module 1901 is configured to: determine that the one or more reception beams correspond to a transmission beam through which the base station transmits a first SS and/or a first PBCH.

Particularly, the first SS and/or the first PBCH are an SS and/or a PBCH that are transmitted by the base station when the terminal initially accesses the base station. Alternatively, the first SS and/or the first PBCH are the last SS and/or PBCH that are received by the terminal before the main radio sleeps.

Alternatively, or additionally, the processing module 1901 is configured to: determine that the one or more reception beams correspond to a transmission beam through which the base station transmits a control resource set.

Alternatively, or additionally, the one or more reception beams include at least one of the following: a best reception beam corresponding to the transmission beam; or one or more secondary-best reception beams corresponding to the transmission beam.

Alternatively, or additionally, the terminal 1900 includes: a first receiving module that is configured to receive a first signaling. The first signaling carries a transmission configuration indication state, and the transmission configuration indication state indicates the transmission beam for the low power wake-up signal.

Particularly, the first signaling includes at least one of the following: an RRC signaling, an MAC CE, or DCI.

Alternatively, or additionally, the terminal 1900 includes: a second receiving module that is configured to receive a second signaling. The second signaling indicates pieces of beam information associated with different monitoring occasions, and the pieces of beam information correspond to the transmission beams used at the monitoring occasions associated with the pieces of beam information.

The processing module 1901 is configured to: determine the one or more reception beams corresponding to each monitoring occasion.

Alternatively, or additionally, the second signaling includes at least one of the following: an RRC signaling, an MAC CE, or DCI.

Alternatively, or additionally, the second signaling further includes at least one of the following: a beam cycle period, which is a count of the monitoring occasions associated with different beam information, and the count is an integer greater than or equal to 2; a beam information field, which includes at least one piece of beam information; a beam association indication field, which indicates a piece of beam information associated with each monitoring occasion; or, indication information about being associated in a default mode, where the indication information indicates that the monitoring occasions in the beam cycle period are associated with the beam information in the beam information field.

With respect to the apparatuses in the foregoing examples, the detailed manner in which each module performs its operation has been described in detail in the examples of the related methods, and will not be described in detail here.

The present disclosure also provides a non-transitory computer-readable storage medium having computer program instructions stored thereon. The program instructions, when executed by one or more processors, implement the steps of the wake-up method in the low power mode provided in the present disclosure.

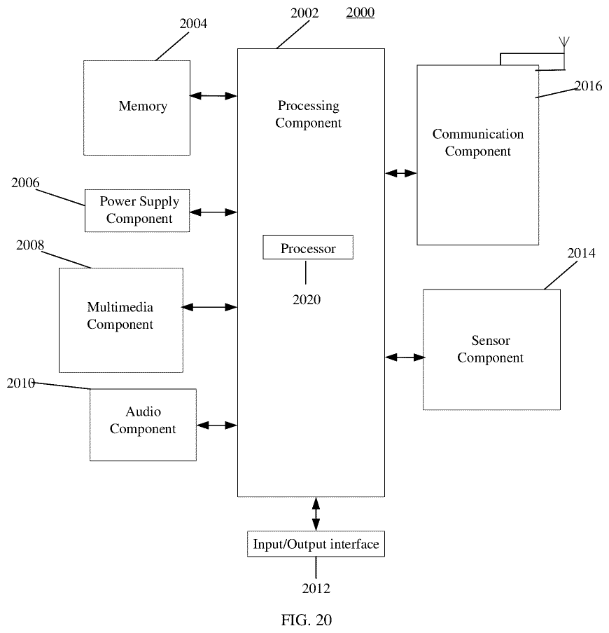

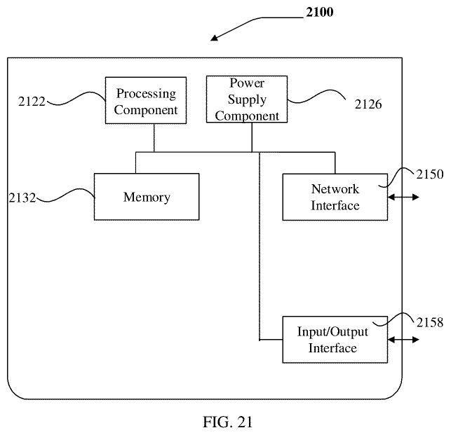

FIG. 20 is a block diagram illustrating a communication device 2000 according to an example. The communication device 2000 may be provided as a terminal. Referring to FIG. 20, the communication device 2000 may include one or more of the following components: a processing component 2002, a memory 2004, a power supply component 2006, a multimedia component 2008, an audio component 2010, an input/output (I/O) interface 2012, a sensor component 2014, and a communication component 2016.

The processing component 2002 generally controls the overall operations of the communication device 2000, such as operations associated with display, phone calls, data communications, camera operations, and recording operations. The processing component 2002 may include one or more processors 2020 to execute instructions to complete all or a part of the steps of the wake-up methods in the low power mode. In addition, the processing component 2002 may include one or more modules which facilitate the interaction between the processing component 2002 and other components. As an example, the processing component 2002 may include a multimedia module to facilitate the interaction between the multimedia component 2008 and the processing component 2002.

The memory 2004 is configured to store various types of data to support the operations of the communication device 2000. Examples of such data include instructions for any application or the wake-up method in the low power mode operated on the communication device 2000, contact data, phonebook data, messages, pictures, videos, and the like. The memory 2004 may be implemented by any type of volatile or non-volatile storage device or a combination thereof, such as a static random access memory (SRAM), an electrically erasable programmable read-only memory (EEPROM), an erasable and programmable read-only memory (EPROM), a programmable read-only memory (PROM), a read-only memory (ROM), a magnetic memory, a flash memory, a magnetic disk or an optical disk.

The power supply component 2006 provides power for various components of the communication device 2000. The power supply component 2006 may include a power management system, one or more power supplies, and other components associated with generating, managing, and distributing power for the communication device 2000.

The multimedia component 2008 includes a screen providing an output interface between the communication device 2000 and a user. In some examples, the screen may include a liquid crystal display (LCD) and a touch panel (TP). If the screen includes the TP, the screen may be implemented as a touch screen to receive input signals from the user. The TP may include one or more touch sensors to sense touches, swipes, and gestures on the TP. The touch sensors may not only sense a boundary of a touch or swipe, but also sense a lasting time and a pressure associated with the touch or swipe. In some examples, the multimedia component 2008 includes a front camera and/or a rear camera. The front camera and/or rear camera may receive external multimedia data when the communication device 2000 is in an operating mode, such as a photographing mode or a video mode. Each of the front and rear cameras may be a fixed optical lens system or have focal length and optical zooming capability.

The audio component 2010 is configured to output and/or input audio signals. For example, the audio component 2010 includes a microphone (MIC) that is configured to receive an external audio signal when the communication device 2000 is in an operating mode, such as a call mode, a recording mode, and a voice recognition mode. The received audio signal may be further stored in the memory 2004 or transmitted via the communication component 2016. In some examples, the audio component 2010 also includes a speaker for outputting audio signals.

The I/O interface 2012 provides an interface between the processing component 2002 and a peripheral interface module. The peripheral interface module may be a keyboard, a click wheel, buttons, or the like. These buttons may include but not limited to a home button, a volume button, a start button and a lock button.

The sensor component 2014 includes one or more sensors to provide the communication device 2000 with state assessments in various aspects. For example, the sensor component 2014 may detect an open/closed state of the communication device 2000 and a relative positioning of components such as the display and keypad of the communication device 2000, and the sensor component 2014 may also detect a change in position of the communication device 2000 or a component of the communication device 2000, the presence or absence of a user contacting with the communication device 2000, orientation or acceleration/deceleration of the communication device 2000, and temperature change of the communication device 2000. The sensor component 2014 may include a proximity sensor configured to detect the presence of a nearby object without any physical contact. The sensor component 2014 may also include an optical sensor, such as a complementary metal-oxide-semiconductor (CMOS) or a charged-coupled device (CCD) image sensor, for being applied in imaging applications. In some examples, the sensor component 2014 may also include an acceleration sensor, a gyro sensor, a magnetic sensor, a pressure sensor, or a temperature sensor.

The communication component 2016 is configured to facilitate wired or wireless communication between the communication device 2000 and other devices. The communication device 2000 may access a wireless network based on a communication standard, such as Wi-Fi, 2G, 3G, 4G, 5G, 6G or a combination thereof. In an example, the communication component 2016 receives broadcast signals or broadcast related information from an external broadcast management system via a broadcast channel. In an example, the communication component 2016 also includes a near field communication (NFC) module to facilitate short-range communication. For example, the NFC module may be implemented based on a radio frequency identification (RFID) technology, an infrared data association (IrDA) technology, an ultra-wideband (UWB) technology, a Bluetooth® (BT) technology and other technologies.

In one or more examples, the communication device 2000 may be implemented by one or more application specific integrated circuits (ASICs), digital signal processors (DSPs), digital signal processing devices (DSPDs), programmable logic devices (PLDs), field programmable gate arrays (FPGAs), controllers, microcontrollers, microprocessors, or other electronic components for performing the wake-up methods in the low power mode.

In one or more examples, there is also provided a non-transitory computer-readable storage medium including instructions, such as the memory 2004 including instructions. These instructions may be executed by the one or more processors 2020 of the communication device 2000 to complete the wake-up methods in the low power mode. For example, the non-transitory computer-readable storage medium may be an ROM, a random access memory (RAM), a CD-ROM, a magnetic tape, a floppy disk, an optical data storage device, and the like.

In another example, a computer program product is further provided. The computer program product includes a computer program that may be executed by a programmable device. The computer program has a code portion for performing the wake-up methods in the low power mode when executed by the programmable device.

FIG. 21 is a block diagram illustrating a communication device according to an example. For example, the communication device 2100 may be provided as an access network device, such as a base station. Referring to FIG. 21, the communication device 2100 includes a processing component 2122 which further includes one or more processors, and a memory resource represented by a memory 2132 which is used to store instructions that may be executed by the processing component 2122, such as application programs. The application programs stored in the memory 2132 may include one or more modules, each of which corresponds to a set of instructions. In addition, the processing component 2122 is configured to execute instructions to perform the steps of the wake-up methods in the low power mode provided in the method examples.

The device 2100 may also include a power supply component 2126 configured to perform power management of the communication device 2100, a wired or wireless network interface 2150 configured to connect the communication device 2100 to a network, and an input/output (I/O) interface 2158. The communication device 2100 may perform operation based on an operating system stored in the memory 2132, such as Windows Server™, Mac OS X™, Unix™, Linux™, or FreeBSD™.

In another example, a computer program product is further provided. The computer program product includes a computer program that may be executed by a programmable device. The computer program has a code portion for performing the wake-up methods in the low power mode when executed by the programmable device.

Other implementations of the present disclosure will be readily apparent to those skilled in the art after implementing the disclosure by referring to the specification. The present disclosure is intended to cover any variations, uses, or adaptations of the present disclosure that are in accordance with the general principles thereof and include common general knowledge or conventional technical means in the art that are not disclosed in the present disclosure. The specification and the examples are only illustrative, and the true scope and spirit of the present disclosure are set forth in the appended claims.

It is to be understood that the present disclosure is not limited to the precise structures described above and illustrated in the accompanying drawings, and that various modifications and changes may be made to the present disclosure without departing from the scope thereof. The scope of the present disclosure is limited only by the appended claims.

1. A wake-up method in a low power mode, performed by a base station, comprising:
determining a transmission beam for a low power wake-up signal, wherein one or more reception beams for receiving the low power wake-up signal by a terminal correspond to the transmission beam; and
transmitting the low power wake-up signal to the terminal according to the transmission beam.

2. The method according to claim 1, wherein determining the transmission beam for the low power wake-up signal comprises:
determining that the transmission beam is identical to a beam for transmitting a first physical downlink control channel (PDCCH),
wherein the first PDCCH carries last downlink control information (DCI) that is received by the terminal before a main radio sleeps, or
wherein the first PDCCH is a last PDCCH that is received by the terminal before the main radio sleeps, or
wherein the first PDCCH schedules a last physical downlink shared channel (PDSCH) that is received before the terminal sleeps, or
wherein the first PDCCH schedules a PDSCH for a last hybrid automatic repeat request (HARQ) feedback before the terminal sleeps.

3. The method according to claim 1, wherein determining the transmission beam for the low power wake-up signal comprises:
determining that the transmission beam is identical to a beam indicated by a second physical downlink control channel (PDCCH),
wherein the second PDCCH carries last downlink control information (DCI) that is received by the terminal before a main radio sleeps, or
wherein the second PDCCH is a last PDCCH that is received by the terminal before the main radio sleeps.

4. The method according to claim 1, wherein determining the transmission beam for the low power wake-up signal comprises:
determining that the transmission beam is identical to a beam for transmitting a first physical downlink shared channel (PDSCH),
wherein the first PDSCH is a last PDSCH that is received by the terminal before a main radio sleeps.

5. The method according to claim 1, wherein determining the transmission beam for the low power wake-up signal comprises:
determining that the transmission beam is identical to a beam for transmitting at least one of a first synchronization signal (SS) or a first physical broadcast channel (PBCH),
wherein the at least one of the first SS or the first PBCH is at least one of an SS or a PBCH that is transmitted by the base station when the terminal initially accesses the base station, or
wherein the at least one of the first SS or the first PBCH is at least one of a last SS or a last PBCH that is received by the terminal before a main radio sleeps.

6. The method according to claim 1, wherein determining the transmission beam for the low power wake-up signal comprises:
determining that the transmission beam is identical to a beam for transmitting a control resource set.

7. The method according to claim 1, further comprising:
transmitting a transmission configuration indication state to the terminal via a first signaling,
wherein the transmission configuration indication state indicates the transmission beam for the low power wake-up signal, and
wherein the first signaling comprises at least one of: a radio resource control (RRC) signaling, a media access control control element (MAC CE), or downlink control information (DCI).

8. The method according to claim 1, wherein determining the transmission beam for the low power wake-up signal comprises:
determining transmission beams corresponding to each monitoring period; and
wherein the method further comprises:
transmitting a second signaling to the terminal,
wherein the second signaling indicates pieces of beam information associated with different monitoring occasions,
wherein the pieces of beam information correspond to the transmission beams used at monitoring occasions associated with the pieces of beam information, and
wherein the second signaling comprises at least one of: a radio resource control (RRC) signaling, a media access control control element (MAC CE), or downlink control information (DCI).

9. (canceled)

10. The method according to claim 8, wherein the second signaling further comprises at least one of:
a beam cycle period, wherein the beam cycle period is a count of the monitoring occasions associated with different beam information, and the count is an integer greater than or equal to 2;
a beam information field, wherein the beam information field comprises at least one piece of beam information;
a beam association indication field, wherein the beam association indication field indicates a piece of beam information associated with each monitoring occasion; or,
indication information about being associated in a default mode, wherein the indication information indicates that the monitoring occasions in the beam cycle period are associated with the at least one piece of beam information in the beam information field.

11. A wake-up method in a low power mode, performed by a terminal, comprising:
determining one or more reception beams, wherein the one or more reception beams correspond to a transmission beam through which a base station transmits a low power wake-up signal;
receiving, according to the one or more reception beams, the low power wake-up signal transmitted by the base station; and
performing a wake-up or changing a sleep state based on the low power wake-up signal.

12. The method according to claim 11, wherein determining the one or more reception beams comprises:
determining that the one or more reception beams correspond to a transmission beam through which the base station transmits a first physical downlink control channel (PDCCH),
wherein the first PDCCH carries last downlink control information (DCI) that is received by the terminal before a main radio sleeps, or
wherein the first PDCCH is a last PDCCH that is received by the terminal before the main radio sleeps, or
wherein the first PDCCH schedules a last physical downlink shared channel (PDSCH) that is received before the terminal sleeps, or
wherein the first PDCCH schedules a PDSCH for a last hybrid automatic repeat request (HARQ) feedback before the terminal sleeps.

13. The method according to claim 11, wherein determining the one or more reception beams comprises:
determining that the one or more reception beams correspond to a transmission beam indicated by a second physical downlink control channel (PDCCH) transmitted by the base station,
wherein the second PDCCH carries last downlink control information (DCI) that is received by the terminal before a main radio sleeps, or
wherein the second PDCCH is a last PDCCH that is received by the terminal before the main radio sleeps.

14. The method according to claim 11, wherein determining the one or more reception beams comprises:
determining that the one or more reception beams correspond to a transmission beam through which the base station transmits a first physical downlink shared channel (PDSCH),
wherein the first PDSCH is a last PDSCH that is received by the terminal before a main radio sleeps.

15. The method according to claim 11, wherein determining the one or more reception beams comprises:
determining that the one or more reception beams correspond to a transmission beam through which the base station transmits at least one of a first synchronization signal (SS) or a first physical broadcast channel (PBCH),
wherein the at least one of the first SS or the first PBCH is at least one of an SS or a PBCH that is transmitted by the base station when the terminal initially accesses the base station, or
wherein the at least one of the first SS or the first PBCH is at least one of a last SS or a last PBCH that is received by the terminal before a main radio sleeps; or
determining that the one or more reception beams correspond to a transmission beam through which the base station transmits a control resource set.

16. (canceled)

17. The method according to claim 11, wherein the one or more reception beams comprises at least one of:
a best reception beam corresponding to the transmission beam; or
one or more secondary-best reception beams corresponding to the transmission beam.

18. The method according to claim 11, further comprising:
receiving a first signaling,
wherein the first signaling carries a transmission configuration indication state, wherein the transmission configuration indication state indicates the transmission beam for the low power wake-up signal; and
wherein the first signaling comprises at least one of: a radio resource control (RRC) signaling, a media access control control element (MAC CE), or downlink control information (DCI).

19. The method according to claim 11, further comprising:
receiving a second signaling, wherein the second signaling indicates pieces of beam information associated with different monitoring occasions, wherein the pieces of beam information correspond to transmission beams used at monitoring occasions associated with the pieces of beam information, and wherein the second signaling comprises at least one of: a radio resource control (RRC) signaling, a media access control control element (MAC CE), or downlink control information (DCI); and
wherein determining the one or more reception beams comprises:
determining the one or more reception beams corresponding to each monitoring occasion.

20. (canceled)

21. The method according to claim 19, wherein the second signaling further comprises at least one of:
a beam cycle period, wherein the beam cycle period is a count of the monitoring occasions associated with different beam information, and the count is an integer greater than or equal to 2;
a beam information field, wherein the beam information field comprises at least one piece of beam information;
a beam association indication field, wherein the beam association indication field indicates a piece of beam information associated with each monitoring occasion; or,
indication information about being associated in a default mode, wherein the indication information indicates that the monitoring occasions in the beam cycle period are associated with the at least one piece of beam information in the beam information field.

22. (canceled)

23. (canceled)

24. A communication device, comprising:
one or more processors; and
one or more memories for storing instructions executable by the one or more processors;
wherein the one or more processors are configured to perform the method according to claim 1.

25. A communication device, comprising:
one or more processors; and
one or more memories for storing instructions executable by the one or more processors;
wherein the one or more processors are configured to:
determine one or more reception beams, wherein the one or more reception beams correspond to a transmission beam through which a base station transmits a low power wake-up signal;
receive, according to the one or more reception beams, the low power wake-up signal transmitted by the base station; and
perform a wake-up or change a sleep state based on the low power wake-up signal.

26. (canceled)

27. (canceled)
